(19) United States
(12) Patent Application Publication
(10) Pub. No.: US 2024/0250275 A1
(43) Pub. Date: Jul. 25, 2024

(54) FUEL CELL STACK

(71) Applicant: TOYOTA BOSHOKU KABUSHIKI KAISHA, Aichi-ken (JP)

(72) Inventor: Haruyuki AONO, Aichi-ken (JP)

(73) Assignee: TOYOTA BOSHOKU KABUSHIKI KAISHA, Aichi-ken (JP)

(21) Appl. No.: 18/410,214

(22) Filed: Jan. 11, 2024

(30) Foreign Application Priority Data
Jan. 20, 2023 (JP) 2023-007225

(51) Int. Cl. H01M 8/0254; H01M 8/2465

(52) U.S. Cl. CPC H01M 8/0254; H01M 8/2465

(57) ABSTRACT

A fuel cell stack includes stacked cells. Each of the cells includes a plastic support frame that supports a membrane electrode assembly at a central portion of the support frame, and includes two separators that sandwich the support frame. The support frame and the two separators each have a through-hole that defines a passage through which fluid flows. An outer surface of each of the two separators in the stacking direction includes a rib. The rib protrudes from an outer edge of the separator and from a peripheral edge of the through-hole of the separator. A shape of the rib on one of the two separators is different from a shape of the rib on the other one of the two separators.

### BACKGROUND

### 1. Field

The present disclosure relates to a fuel cell stack.

### 2. Description of Related Art

Japanese Laid-Open Patent Publication No. 2017-76512 discloses a typical example of a fuel cell stack. Such a fuel cell stack is formed by stacking thin plate-shaped cells. Each cell includes a plastic support frame that supports a membrane electrode assembly. The cell also includes two separators that sandwich the support frame.

In the fuel cell stack, the thin plate-shaped cells have a relatively low rigidity and are thus likely to be warped. Thus, stabilizing the cells in a stacked state is difficult.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A fuel cell stack according to an aspect of the present disclosure includes stacked cells. Each of the cells includes a plastic support frame that supports a membrane electrode assembly at a central portion of the support frame. Each of the cells further includes two separators that sandwich the support frame. The support frame and the two separators each include a through-hole that defines a passage through which fluid flows. The passage extends in a stacking direction of the cells. An outer surface of each of the two separators in the stacking direction includes a rib. The rib protrudes from an outer edge of the separator and from a peripheral edge of the through-hole of the separator. A shape of the rib on one of the two separators is different from a shape of the rib on the other one of the two separators.

Other features and aspects will be apparent from the following detailed description, the drawings, and the claims.

### BRIEF DESCRIPTION OF DRAWINGS

FIG. 1 is a schematic cross-sectional view of a fuel cell according to an embodiment.

FIG. 2 is an exploded perspective view of the cell according to the embodiment.

FIG. 3 is a plan view showing the key section when the first rib and the second rib of the separators of adjacent cells overlap each other in the embodiment.

FIG. 4 is a plan view showing the key section when the first rib and the second rib of the separators of adjacent cells overlap each other in a modification.

FIG. 5 is a plan view showing the key section when the first rib and the second rib of the separators of adjacent cells overlap each other in a modification.

FIG. 6 is a plan view showing the key section when the first rib and the second rib of the separators of adjacent cells overlap each other in a modification.

FIG. 7 is a plan view showing the key section when the first rib and the second rib of the separators of adjacent cells overlap each other in a modification.

FIG. 8 is a plan view of the separators according to a modification.

FIG. 9 is a plan view of the separators according to a modification.

FIG. 10 is a plan view of the separators according to a modification.

FIG. 11 is a plan view of the separators according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the modes, devices, and/or systems described. Modifications and equivalents of the modes, devices, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A fuel cell according to an embodiment will now be described with reference to the drawings.

### Fuel Cell 11

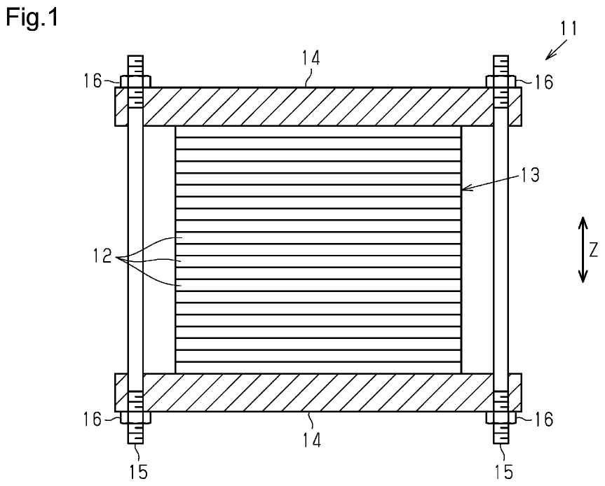

As shown in FIG. 1, a fuel cell 11 includes a fuel cell stack 13 and two end plates 14. The fuel cell stack 13 includes rectangular cells 12, each generating power. The cells 12 are stacked in their thickness direction. The two end plates 14 sandwich the fuel cell stack 13 from the opposite sides of the cell 12 in a stacking direction Z. The two end plates 14 are pressed so as to compress the fuel cell stack 13 in the stacking direction Z by fastening the outer edges of the end plates 14 using bolts 15 and nuts 16. A terminal plate (not shown), which collects current, and an insulating plate (not shown), which performs insulation, are arranged between the fuel cell stack 13 and each of the two end plates 14.

### Cell 12

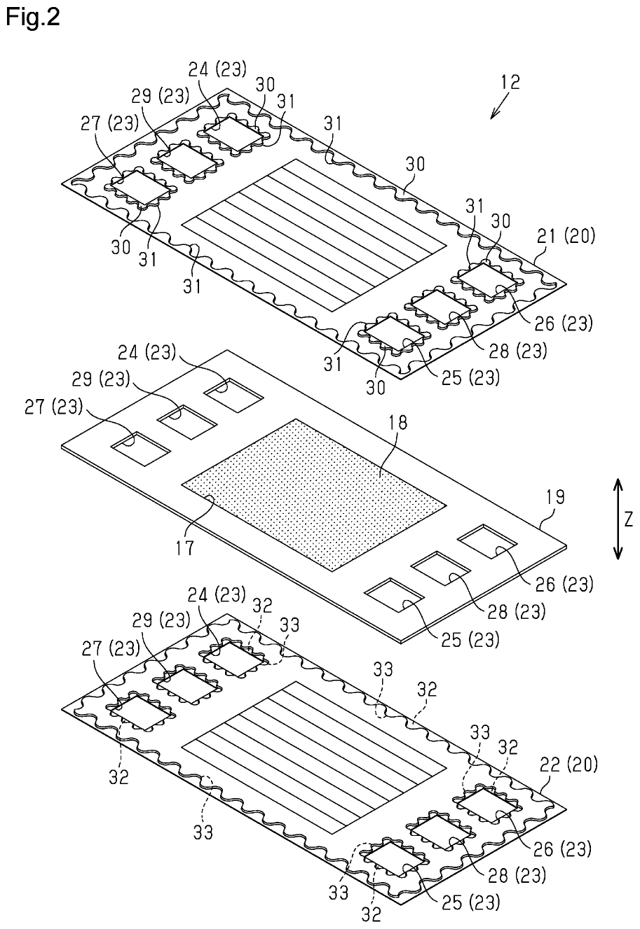

As shown in FIG. 2, the cell 12 includes a plastic support frame member 19 and two metal separators 20. The support frame 19 supports a membrane electrode assembly (MEA) 18 at a central portion of the support frame 19. The separators 20 sandwich the support frame 19 that supports the membrane electrode assembly 18. Specifically, the support frame 19 supports the membrane electrode assembly 18, having a rectangular sheet shape, in a rectangular opening 17 at the central portion. One of the two separators 20 is a first separator 21, and the other one is a second separator 22.

When a portion of the membrane electrode assembly 18 at one end (anode side) in the stacking direction Z is supplied with fuel gas and a portion of the membrane electrode assembly 18 at the other end (cathode side) is supplied with oxidant gas, each cell 12 generates power from an electrochemical reaction of the fuel gas and the oxidant gas in the membrane electrode assembly 18. The opposite ends of the cell 12 in the longitudinal direction, that is, the opposite ends of the support frame 19, the first separator 21, and the second separator 22 in the longitudinal direction each have multiple (six in this example) through-holes 23. For example, each through-hole 23 is quadrilateral.

These six through-holes 23 are referred to as a fuel gas supply hole 24, a fuel gas discharge hole 25, an oxidant gas supply hole 26, an oxidant gas discharge hole 27, a cooling medium supply hole 28, and a cooling medium discharge hole 29. The fuel gas supply hole 24 defines a passage which extends in the stacking direction Z and to which fuel gas, which is an example of fluid, is supplied. The fuel gas discharge hole 25 defines a passage which extends in the stacking direction Z and from which fuel gas is discharged.

The oxidant gas supply hole 26 defines a passage which extends in the stacking direction Z and to which oxidant gas, which is an example of fluid, is supplied. The oxidant gas discharge hole 27 defines a passage which extends in the stacking direction Z and from which oxidant gas is discharged. The cooling medium supply hole 28 defines a passage which extends in the stacking direction Z and to which coolant, which is an example of fluid, is supplied. The cooling medium discharge hole 29 defines a passage which extends in the stacking direction Z and from which coolant is discharged.

### First Separator 21

As shown in FIG. 2, the outer surface of the first separator 21 in the stacking direction Z includes a first rib 30, which is an example of a rib, and the first rib 30 protrudes from the entire outer edge of the first separator 21 and from the entire peripheral edge of each through-hole 23. That is, the first rib 30 is located on a surface of the first separator 21 on a side opposite to the support frame 19.

The first rib 30 is formed by pressing the first separator 21. Thus, a portion of the inner surface of the first separator 21 in the stacking direction Z corresponding to the first rib 30 is recessed by an amount corresponding to the amount by which the first rib 30 protrudes outward in the stacking direction Z. The first rib 30 includes a first corrugated portion 31, which is an example of a corrugated portion having a constant period and amplitude.

The first rib 30, on the outer edge on the outer surface of the first separator 21 in the stacking direction Z, extends in a quadrilateral loop along the outer edge of the first separator 21, and includes a first corrugated portion 31 at a portion (inner portion) opposite to the outer edge of the first separator 21. The first rib 30, on the peripheral edge of each through-hole 23 on the outer surface of the first separator 21 in the stacking direction Z, extends in a quadrilateral loop along the periphery of the through-hole 23, and has a first corrugated portion 31 at a portion (outer portion) opposite to the through-hole 23.

### Second Separator 22

As shown in FIG. 2, the outer surface of the second separator 22 in the stacking direction Z includes a second rib 32, which is an example of a rib, and the second rib 32 protrudes from the entire outer edge of the second separator 22 and from the entire peripheral edge of each through-hole 23. That is, the second rib 32 is located on a surface of the second separator 22 on a side opposite to the support frame 19.

The second rib 32 is formed by pressing the second separator 22. Thus, a portion of the inner surface of the second separator 22 in the stacking direction Z corresponding to the second rib 32 is recessed by an amount corresponding to the amount by which the second rib 32 protrudes outward in the stacking direction Z. The second rib 32 includes a second corrugated portion 33, which is an example of a corrugated portion having a constant period and amplitude.

The second rib 32, on the outer edge on the outer surface of the second separator 22 in the stacking direction Z, extends in a quadrilateral loop along the outer edge of the second separator 22, and includes a second corrugated portion 33 at a portion (inner portion) opposite to the outer edge of the second separator 22. The second rib 32, on the peripheral edge of each through-hole 23 on the outer surface of the second separator 22 in the stacking direction Z, extends in a quadrilateral loop along the periphery of the through-hole 23 and has a second corrugated portion 33 at a portion (outer portion) opposite to the through-hole 23.

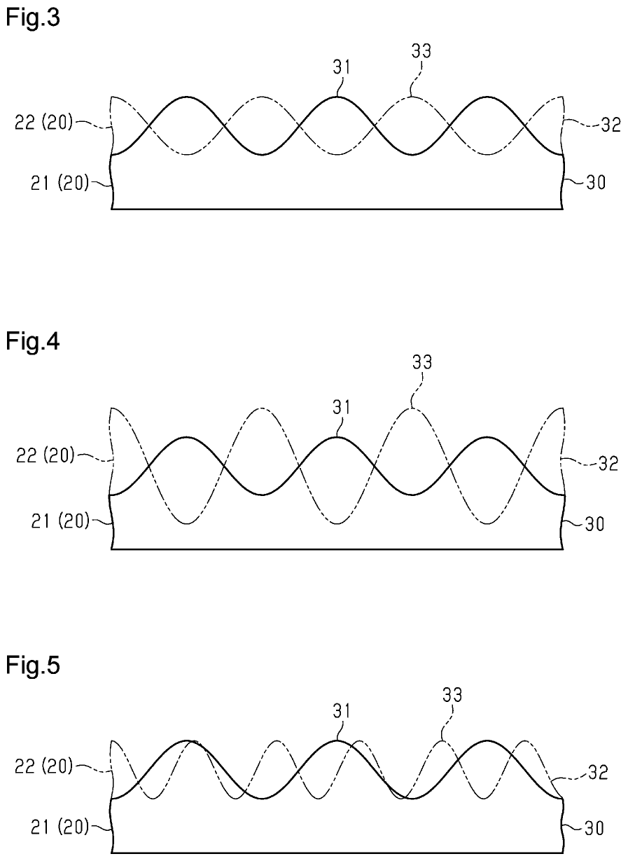

As shown in FIGS. 2 and 3, the second corrugated portion 33 of the second rib 32 has the same period and amplitude as the first corrugated portion 31 of the first rib 30. The phases of the first corrugated portion 31 and the second corrugated portion 33 are shifted from each other by a period shorter than one period. In the present example, the phases of the first corrugated portion 31 and the second corrugated portion 33 are shifted from each other by a half period. Thus, the shape of the first rib 30 and the shape of the second rib 32 are different from each other.

### Operation of Embodiment

As shown in FIGS. 1 to 3, in the fuel cell stack 13 including the stacked cells 12, the first rib 30 of the first separator 21 of one of the two cells 12 adjacent to each other in the stacking direction Z and the second rib 32 of the second separator 22 of the other cell 12 are in contact with each other. That is, the first rib 30 and the second rib 32, each having a different shape, are in contact with each other. In this case, particularly, the phases of the first corrugated portion 31 and the second corrugated portion 33 are shifted from each other by a half period.

Thus, as compared to when the first rib 30 and the second rib 32 have the same shape and are in contact with each other without being shifted from each other in the direction orthogonal to the stacking direction Z, the cells 12 in the stacked state are reinforced in a well-balanced manner. This improves the rigidity of each cell 12 in the stacked state and thus limits warping of the cell 12. This stabilizes the cells 12 in the stacked state.

If the first rib 30 and the second rib 32 have the same shape, the first rib 30 and the second rib 32 are in contact with each other so as not to protrude from each other. For this reason, in each of the stacked cells 12, only the portion where the first rib 30 and the second rib 32 overlap is intensively reinforced. Accordingly, the balance of reinforcement of the cells 12 in the stacked state by the first rib 30 and the second rib 32 is inadequate.

### Advantages of Embodiment

The embodiment described above in detail has the following advantages.
(1) In the fuel cell stack 13, the shape of the first rib 30 on the first separator 21 and the shape of the second rib 32 on the second separator 22 are different from each other.

In this configuration, when the cells 12 are stacked, the first rib 30 and the second rib 32, each having a different shape, come into contact with each other. The first rib 30 and the second rib 32 come into contact with each other so as to protrude from each other. Thus, as compared to when the first rib 30 and the second rib 32 have the same shape, each cell 12 in the stacked state is reinforced in a well-balanced manner. This improves the rigidity of the cells 12 in the stacked state and thus limits warping of the cells 12. This stabilizes the cells 12 in the stacked state.
(2) In the fuel cell stack 13, the first rib 30 on the first separator 21 and the second rib 32 on the second separator 22 respectively include the first corrugated portion 31 and the second corrugated portion 33, having the same period and amplitude. The phases of the first corrugated portion 31 and the second corrugated portion 33 are shifted from each other by a half period.

In this configuration, each cell 12 in the stacked state is reinforced in a more balanced manner by the first rib 30 and the second rib 32 overlapping each other, with the phases of the first corrugated portion 31 and the second corrugated portion 33 being shifted from each other by a half period.

### Modifications

The above embodiment may be modified as follows. The above embodiment and the following modifications can be combined as long as the combined modifications remain technically consistent with each other.

As shown in FIG. 4, the amplitude of the second corrugated portion 33 of the second rib 32 may be different from the amplitude of the first corrugated portion 31 of the first rib 30. That is, for example, the amplitude of the second corrugated portion 33 of the second rib 32 may be larger than the amplitude of the first corrugated portion 31 of the first rib 30.

As shown in FIG. 5, the period of the second corrugated portion 33 of the second rib 32 may be different from the period of the first corrugated portion 31 of the first rib 30. That is, for example, the period of the second corrugated portion 33 of the second rib 32 may be shorter than the period of the first corrugated portion 31 of the first rib 30.

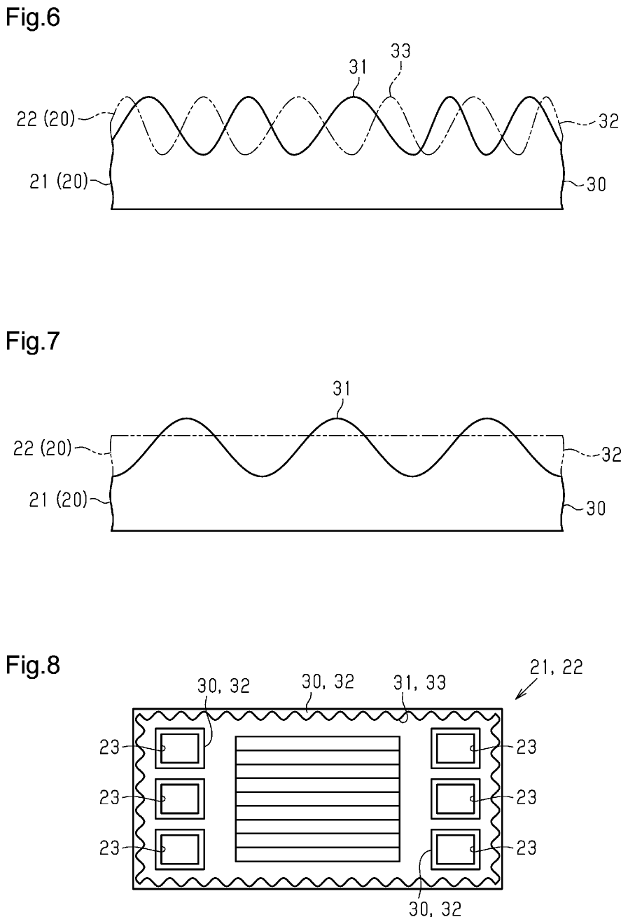

As shown in FIG. 6, the period of the second corrugated portion 33 of the second rib 32 and the period of the first corrugated portion 31 of the first rib 30 may be irregular.

As shown in FIG. 7, the second rib 32 may have a straight shape without the second corrugated portion 33.

In the same manner as the second rib 32 shown in FIG. 7, the first rib 30 may have a straight shape without the first corrugated portion 31.

As shown in FIG. 8, in the first separator 21 and the second separator 22, if the shapes of the portions where the first ribs 30 and the second ribs 32 are in contact with each other are different, the shape of the first rib 30 or the second rib 32 on the peripheral edge of each through-hole 23 may have a straight shape. The straight first ribs 30 and second ribs 32 do not have the first corrugated portions 31 and second corrugated portions 33, respectively.

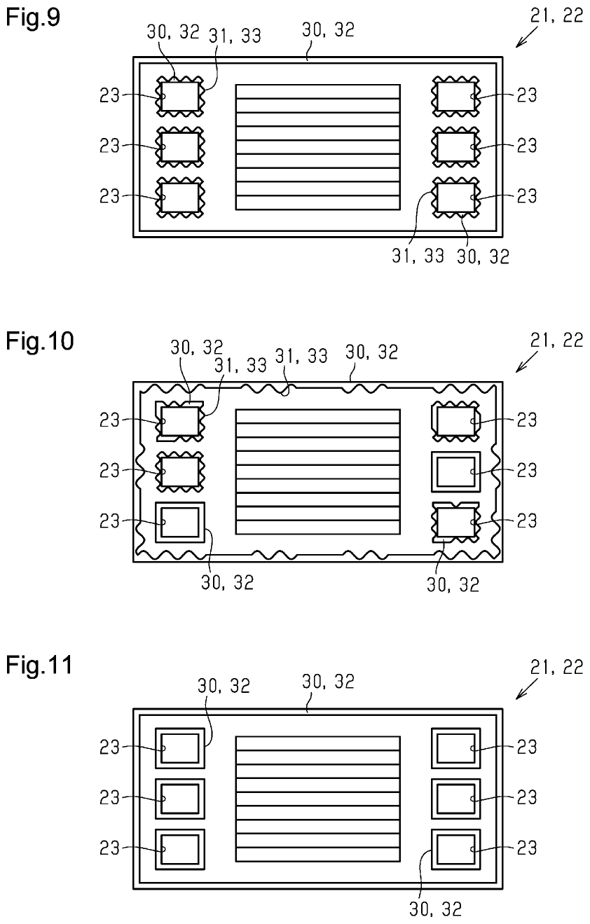

As shown in FIG. 9, in the first separator 21 and the second separator 22, if the shapes of the portions where the first ribs 30 and the second ribs 32 are in contact with each other are different, the shapes of the first rib 30 or the second rib 32 on the outer edge may have a straight shape. The straight first ribs 30 and second ribs 32 do not have the first corrugated portions 31 and second corrugated portions 33, respectively.

As shown in FIG. 10, in the first separator 21 and the second separator 22, if the shapes of the portions where the first ribs 30 and the second ribs 32 are in contact with each other are different, the shapes of the first ribs 30 or the second ribs 32 on the outer edges and the peripheral edges of the through-holes 23 may partially have a straight shape.

As shown in FIG. 11, in the first separator 21 and the second separator 22, the first ribs 30 or the second ribs 32 on the outer edge and the peripheral edge of each through-hole 23 may have a straight shape.

The phases of the first corrugated portion 31 and the second corrugated portion 33 do not have to be shifted from each other by a half period; for example, they may be shifted from each other by a quarter period or a sixth period.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A fuel cell stack, comprising stacked cells, wherein
each of the cells includes:
a plastic support frame that supports a membrane electrode assembly at a central portion of the support frame; and
two separators that sandwich the support frame,
the support frame and the two separators each have a through-hole that defines a passage through which fluid flows, the passage extending in a stacking direction of the cells,
an outer surface of each of the two separators in the stacking direction includes a rib, the rib protruding from an outer edge of the separator and from a peripheral edge of the through-hole of the separator, and
a shape of the rib on one of the two separators is different from a shape of the rib on the other one of the two separators.

2. The fuel cell stack according to claim 1, wherein at least one of the rib on one of the two separators and the rib on the other one of the two separators includes a corrugated portion.

3. The fuel cell stack according to claim 1, wherein the rib on one of the two separators and the rib on the other one of the two separators each include a corrugated portion, the corrugated portions having the same period and amplitude, and phases of the corrugated portions being shifted from each other by a period shorter than one period.
